(19) United States
(12) Patent Application Publication
(10) Pub. No.: US 2002/0054331 A1
(43) Pub. Date: May 9, 2002

(54) Method for remote printing and sending cards and a system for the same

(76) Inventors: Toru Takenobu, Kyoto (JP); Masato Yoshida, Kyoto (JP); Yoshiro Tasaka, Kyoto (JP); Sadao Sugiyama, Kyoto (JP); Yasuhiro Yawata, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 09/907,662

(22) Filed: Jul. 19, 2001

(30) Foreign Application Priority Data
Jul. 25, 2000 (JP) 2000-223980

(51) Int. Cl. G06K 1/00; G06F 15/00

(52) U.S. Cl. 358/1.15

(57) ABSTRACT

A method and system to send a card with a photograph able to remotely create a post-card, with a photo taken by a sender, and send the postcard to any destination regardless of who is to receive it. In particular, this invention discloses a method by which a customer can use a photo terminal having a communication capacity connected via a computer network to the computer system at a print shop to request that the print shop remotely creates and sends a card with a photo on it. The image to be printed on the card and the text data, including the name and address of the recipient and the name of the sender, are transmitted from the photo terminal to the computer network, and the customer requests that the print shop remotely creates and sends the card. The computer system at the print shop receives the image and text sent via the computer network, and the order to print remotely and send the postcard. The system prints the image and the specific text data it has received on a card to create a picture postcard, which it then sends.

### FIELD OF THE INVENTION

This invention concerns a method and a system to remotely create and send cards such as postcards with photographs printed on them. More specifically, this invention concerns a method and a system by which a customer or sender desiring to remotely send a picture postcard uses a photo terminal connected to a print shop's computer system via a computer network to order the print shop to create a picture postcard remotely and send it with a photograph printed on it to the address indicated by the customer.

### BACKGROUND OF THE INVENTION

Picture postcards with photographs of scenic views or historic places are sold in virtually all tourist locations. Tourists commonly send a picture postcard purchased in a given location to their friends or relatives. Senders must write a message on the card, put a stamp on it and mail it at a local post office or drop it in a mailbox. Once it is mailed, the picture postcard must be collected and brought to the main post office for that region and then sent to a regional post office for its destination.

Picture postcards can only be mailed from places which have postal facilities. When there is no post office or mailbox, tourists can neither buy stamps nor mail picture postcards. When the picture postcard's destination is far from where it is mailed, or when it is mailed in a remote location from the tourist location, it will take many days to be delivered. Furthermore, conventional ready made picture postcards sold in a tourist location do not have an individual image photo of a tourist, thus the card cannot convey the feeling of being in that actual place and is unlikely to excite much interest in the person who receives it.

In the last few years, cell phones with digital cameras have become more and more popular. With this kind of phone, it is possible to transmit a photograph directly from one's current location. However, for this scheme to work, the person receiving the photo must have the same equipment or even more hardware than the sender, so the number of people who can receive digital photos is quite limited.

A widely used method of creating a picture postcard independently is to take a photo with a digital camera, enter the image into one's personal computer, and use that image as a database to edit and print a picture postcard. However, this method of producing a postcard entails a great deal of work by the user. A person who is unfamiliar with using a personal computer or processing images will not find it easy to create personalized postcards.

### SUMMARY OF THE INVENTION

The invention provides a method and system to send a card with a photograph on it whereby a sender can remotely create a postcard on which is printed a photo taken by the customer or sender and then send the postcard immediately to any destination regardless of who is to receive it.

The invention also provides a method and system to send a card with a photograph on it which will allow a person who is unfamiliar with using a personal computer or processing images to create and send a card with a photo on it.

This invention provides a method by which a customer can use a photo terminal having a communication capacity connected via a computer network to the computer system at a print shop to request that the print shop remotely creates and sends a card with a photo on it. The image to be printed on the card and the text data, including the name and address of the recipient and the name of the sender, are transmitted from the photo terminal to the computer network along with a customer request that the print shop remotely create and send the card. The computer system at the print shop receives the image and text sent via the computer network as well as the order to print remotely and send the postcard. The print shop then prints the image and the specific text data it has received on a card, thereby creating a picture postcard, which it then sends.

The phrase “print shop” used herein refers to any enterprise which offers printing as one of its services. It thus includes not only privately-owned print shops but also government-operated enterprises such as the Post Office. The “card with a photograph on it” would typically be a postcard with a photo; but it could also, to give one example, be a message card with a photo which is attached to merchandise like flowers. The item referred to as a “card” would generally be a sheet of a thicker stock such as would be used for postcards or message cards. However, its meaning would include any card whose purpose is to transmit a message, regardless of its material, size, shape, thickness, etc.

The “text data including the name and address to which the card is to be sent and the name of the sender” includes at least the address of the recipient and the name of the sender. They may also include a message to the recipient.

With this invention, the image and text data including the recipient's name and address and the name of the sender are sent from a photo terminal to a computer network. The print shop is then requested to remotely create and send a card with a photograph on it. The print shop prints the image it has received and the specified text data to create a card with a photo, which it then sends to the designated recipient. A photo terminal can be located at any location where a tourist might wish to create a personalized postcard or other card with one of his own photographs. Even if the sender is in a location with no postal facilities whatsoever, the sender can send cards with photographs to family or friends in a short time at any hour of the day or night. A sender can also send the same card to different people simultaneously.

In an exemplary embodiment of this invention, the card with a photograph on it is a postcard. On a picture postcard, the photo and message are printed on the back of the card and the name and address of the recipient as well as the name of the sender is printed on the card's front. If the card is a message card attached to merchandise, the destination (and in particular the address) need not be printed on the card.

With the system to send a photo card in which the method according to this invention is implemented, the photo terminal provided with a communication capacity has an image input means to input the image to be printed on the card; a text input means to input the text data, including the name and address of the recipient and the name of the sender; and a communication means to transmit the image and text data entered via the image and text input means to a computer network and request that a print shop create and send a photo card.

The computer at the print shop has a receiving means to receive the image and text data transmitted via the computer network and the request to remotely create and send a photo card; and a printing means to print on a card the image and specific text data it has received via its receiving means so as to create a photo card.

The photo terminal provided with a communication capacity may be realized in a number of ways. In the first embodiment of this invention, the photo terminal is a cell phone with a built-in digital camera. With this cell phone, the image to be printed on the card is photographed and input by the digital camera which serves as the image input means to input the image. The text data, including the recipient's name and address and the sender's name, are input using the ten keys on the touchtone phone as the means to input data. The image and text data which are input are transmitted to the computer network, and the print shop is requested to remotely create and send a photo card.

With this embodiment, the user can take a photo anyplace he wishes and immediately request that the image he has photographed be used to remotely create and send a card such as a picture postcard. This will allow him to convey to his family and friends the feeling of visiting the actual place.

In another exemplary embodiment of this invention, the photo terminal is a personal computer capable of accepting image input. In this embodiment, the image to be printed on the card is captured with a digital camera and entered into a personal computer. The text data, including the recipient's name and address and the sender's name, are input via a keyboard which serves as the text input means to input the data. The image and text data that are input are transmitted by a modem to a computer network, and the print shop is requested to remotely create and send the photo card.

In this embodiment, a personal computer serves as the photo terminal, so the image is captured in one place and the request to remotely create and send a photo card is sent from another place. The image which is captured is input into the personal computer wherever the computer is installed, and from there the print shop is requested to remotely create and deliver the photo card.

In yet another exemplary embodiment of this invention, the photo terminal comprises a housing which can be set up on the ground and which contains an image processing device to generate an image of a person and process that image; an illumination device which lights the person; and a communication device which can be connected to the computer network. The image processing device comprises an imaging means to photograph a person; a text input means to input text data, including the name and address of the recipient of the photo card and the name of the sender; and a display means to display the image and text data.

The photo terminal of this embodiment may be installed in a building such as the nearest station to the tourist location. If the terminal is equipped with a rain shelter, it may even be installed outdoors. With the photo terminal of this embodiment, the person is photographed by the imaging means when lit by the illumination device. He inputs the text data, including the name and address of the recipient of the photo card and the name of the sender, using the text input means. Since the image obtained and the text data which have been input are displayed on the display means, the user can view the image and text data to determine whether they are acceptable. The image and text data are transmitted by the communication device to the computer network, and the print shop is asked to remotely create and deliver a photo card.

In this embodiment, there is no need for an imaging device which is separate from the photo terminal. In this respect the embodiment differs from those previously described. With this embodiment, the photo is taken where the photo terminal is installed. The user can instantly request that a print shop remotely create and deliver a card, a postcard or other picture postcard on which a captured image is printed.

### BRIEF DESCRIPTION OF THE DRAWINGS

These and other aspects and features of the invention will be better understood from the following detailed description which is provided with the accompanying drawings.

FIG. 1 illustrates a schematic drawing of a system for sending picture postcards related to the invention;

FIG. 2 illustrates an embodiment of a system to remotely create and send picture cards;

FIG. 3 illustrates a processing sequence occurring when a print shop receives an order via photo terminal to create and send a picture postcard;

FIG. 4 (1) illustrates a sample image on a display;

FIG. 4 (2) illustrates one side of a picture postcard according to the invention;

FIG. 4 (3) illustrates a side of a picture postcard with an image and text data; and

FIG. 5 illustrates another embodiment of a system to remotely create and send picture cards.

### DETAILED DESCRIPTION OF THE INVENTION

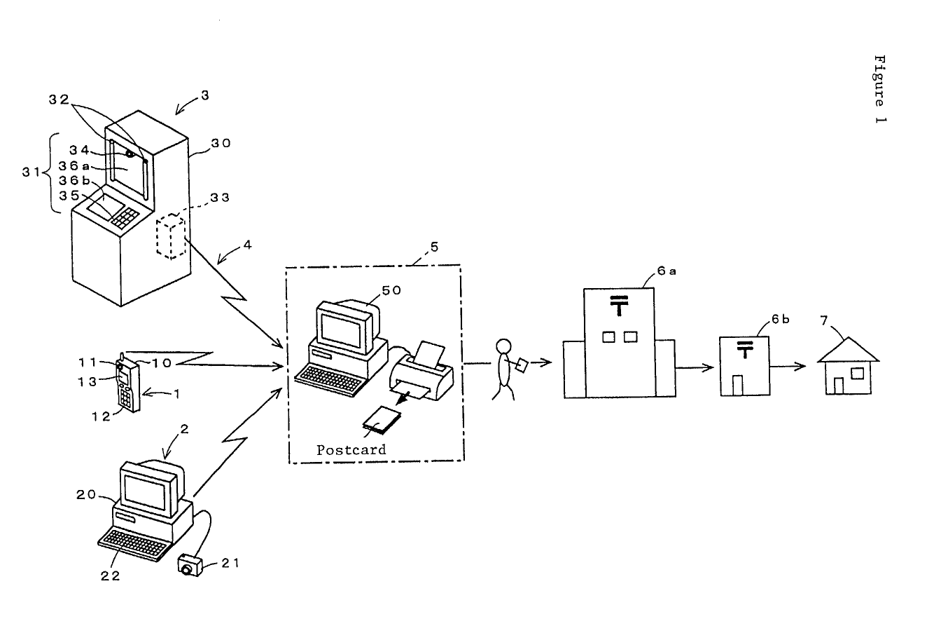

FIG. 1 displays a schematic drawing of a system for sending picture postcards related to this invention. A customer can use one of photo terminal devices 1 through 3, which are connected to a print shop's computer system 5 through computer network 4, to request the print shop remotely create and send a postcard with a photo on it.

A sender or person sending a message card or postcard (i.e., the person ordering that a card be sent) uses one of photo terminals 1 through 3 to send an image to be printed on the card as well as text data, including the name and address of a recipient, the sender's name and address, and the sender's message to computer network 4. Sender thereby requests the print shop to remotely create and send a card with the transmitted photo and text on it.

Photo terminal 1 is a cell phone 10 with a built-in digital camera 11 according to an exemplary embodiment of this invention. Digital camera 11 is used to photograph people or scenery and generate an image to be printed on a card. Cell phone 10 has ten touchtone keys 12 which, in addition to phone numbers, can input the recipient's name and address, the sender's name and address and sender's message. The cell phone 10 also has a display 13 which shows the input image and text data.

Photo terminal device 2 is a personal computer 20 according another exemplary embodiment. The image captured by digital camera 21 is entered into personal computer 20. Text data, which include a recipient's name and address, the sender's name and address and sender's message are entered via keyboard 22. The image and text data which are input are sent to computer network 4 by a built-in modem, along with a user request that a print shop to remotely create and send a postcard with a photo on it.

Photo terminal device 3 is a dedicated device 30, according to yet another exemplary embodiment, by which the user can request that the print shop remotely creates and sends a postcard with a photo on it. Device 30 has, in a housing which can be installed on the ground, an image processing device 31 to generate and process an image of a person; two fluorescent lamps 32 to illuminate the person; and communication device 33, which can be connected to computer network 4. The image processing device 31 contains a camera 34, which photographs the person; key panel 35, which is used to input the text data, including the recipient's name and address, the sender's name, address and message; display 36a, which displays the image which has been input; and display 36b, which displays the text data which has been input.

Camera 34 photographs the subject, who is lit by fluorescent lamps 32. The sender then uses key panel 35 to input the recipient's name and address, the sender's name and address and the sender's message. The image captured by the image processing device 31 is displayed on screen 36a and the text data which has been input by sender is displayed on screen 36b. The image and text data are sent to computer network 4 by communication device 33, and a print shop is requested to remotely create and send a postcard with a photo on it.

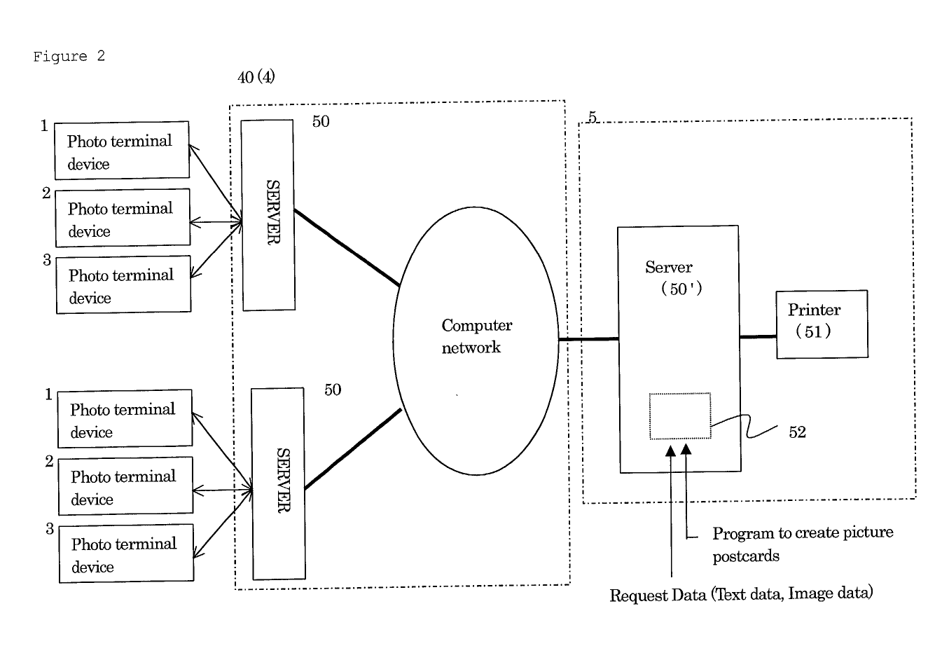

As shown in FIG. 2, server 50′ in the print shop's computer system 5 receives the image and text data sent through computer network 4 from photo terminals 1, 2 or 3. When the shop receives the request to remotely create and send a picture postcard, printer 51 prints the image and the message on the back of the postcard and the name and address of the recipient and the sender on the front to create a picture postcard.

Referring to FIG. 1, after a print shop employee places a postal stamp on the postcard, the employee takes it to the nearest post office 6a (for example, the Central Post Office in Tokyo) and mails it. Once mailed, the postcard is sent from post office 6a to the local post office 6b nearest its destination. From post office 6b it is delivered to recipient 7.

In this embodiment a privately owned print shop remotely creates a picture postcard. However, the postcard could just as well be created remotely at a specified post office 6a or even at the local post office 6b.

FIG. 2 shows the configuration of a system to send picture postcards according to an exemplary embodiment of this invention. In the system pictured in the drawing, a number of servers 50 are connected to the internet 40 through communication circuits. Photo terminals 1 through 3 are connected to each server 50 through communication circuits. Server 50′, which is a part of the print shop's computer system 5, is connected to internet 40, and printer 51 is connected to server 50′.

The print shop's server 50′ contains a memory device 52. Request data from photo terminals (1, 2 or 3) and the program to create picture postcards are stored in memory device 52. Each set of request data includes both image and text data. The program to create picture postcards is provided to photo terminals 1 and 2. Photo terminal 3 stores such a program in its internal memory.

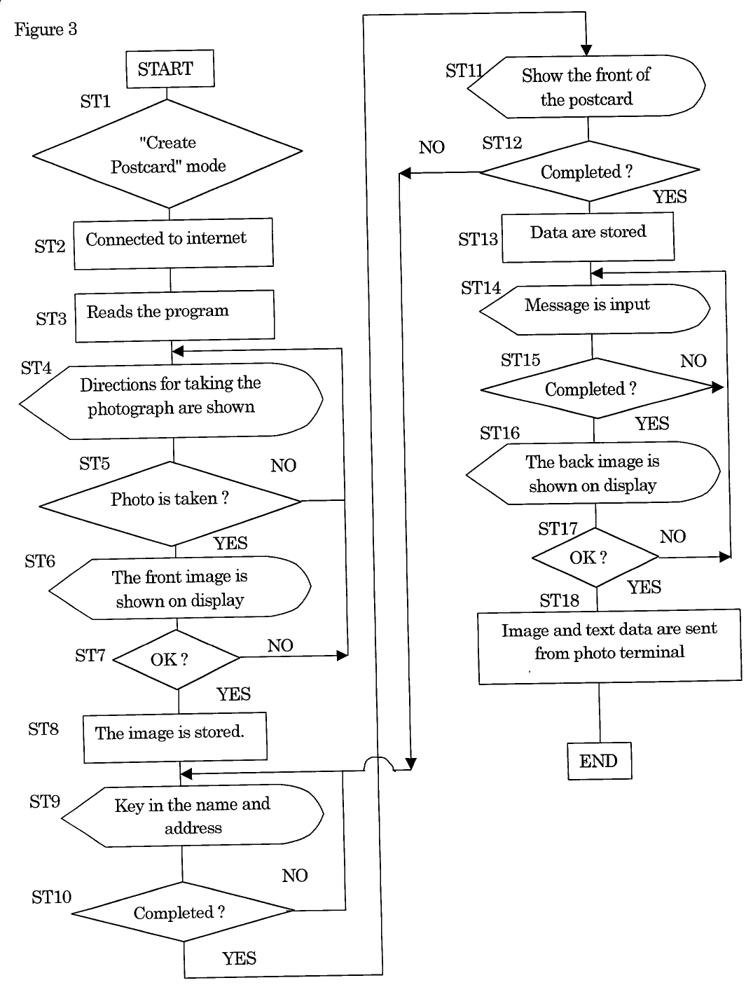

FIG. 3 shows the flow of operations which occurs when the print shop receives an order via photo terminal 1 (cell phone type) according to one of the exemplary embodiments to create and send a picture postcard. In the drawing “ST” is an abbreviation for “step.”

In Step 1, the customer selects “Create Postcard” mode from the menu offered on display 13. The photo terminal 1 is then connected to internet 40, and it reads the program from the print shop's server 50′ to create picture postcards. Directions for taking the photograph are shown on display 13 (Steps 2 through 4).

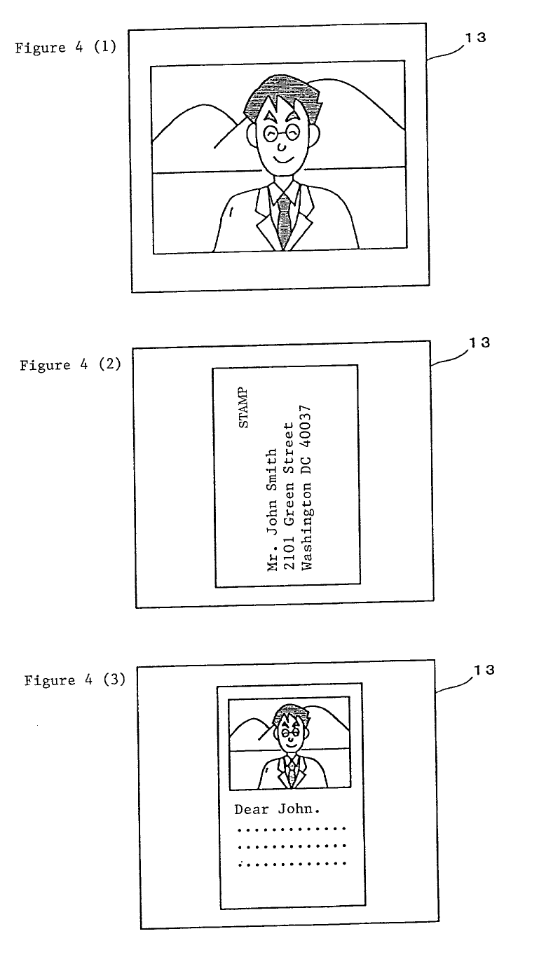

When digital camera 11 is focused on the subject or customer and the photo is taken, the judgment in Step 5 will be “Yes. ” The image which was photographed is then shown on display 13 (Step 6). FIG. 4 (1) shows the screen which will be shown at this point on display 13. The sender views the image which is displayed and determines whether to select it. If the sender is not pleased with the displayed image, the answer in Step 7 will be “No”, and another photo will be taken. This operation will be repeated until the user or sender sees an image that he likes.

When the customer presses specified keys to select the image which is displayed, the answer in Step 7 is “Yes”. The image is stored in the camera's 11 memory, and the user is given instructions on display 13 to key in the name and address of the recipient and sender's own name and address (Steps 8 and 9).

When the sender presses keys 12 to input the recipient and sender's name and address, the answer in Step 10 will be “Yes”. Display 13 will next display the front of the postcard (FIG. 4(2)) with the recipient and sender's names and addresses on it (Step 11). The sender views the image which is displayed and determines whether the input information is correct. If data is incorrect, the answer in Step 12 will be “No”, and sender will re-input the data. This operation is repeated until the input is correct.

When the customer presses the specified keys to select the image which is displayed, the answer in Step 12 will be “Yes”. The text data for the recipient and sender's names and addresses are stored in memory, and display 13 shows instructions to input a message to the recipient (Steps 13 and 14).

When the sending customer uses keys 12 to input a message, the answer in Step 15 will then be “Yes”. Display 13 next shows the back of the postcard with the image and message on it (FIG. 4(3)) (Step 16). When the sending customer views this display, the sender determines whether the message is satisfactory. If it is not, the answer in Step 17 will be “No”, and sender will key in another message.

When the sender ultimately presses a specified key to select the image that is displayed, the answer in Step 17 will go to “Yes”. The image and text data are then sent from photo terminal 1 to computer network 4, and a print shop is requested to remotely create and send a postcard with the photo on it. The flow of operations when the order is sent from photo terminal 2 or 3 is similar to that shown in FIG. 3, therefore a full discussion of the other two terminals is not included.

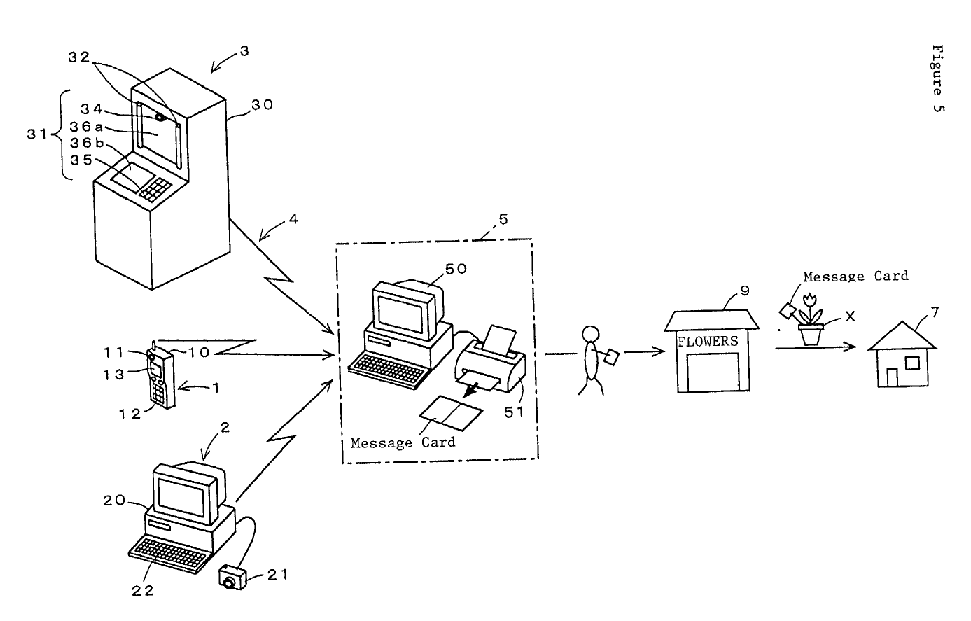

The embodiment discussed above concerns a system to send postcards with photos on them. However, the invention is not limited to picture postcards, but could also be implemented in a system to create message cards with photos on them which could be sent with flowers or other merchandise X, as shown in FIG. 5.

In the system shown in FIG. 5, when a print shop receives an order from photo terminals 1 through 3, the computer system 5 in the print shop creates message card with a photo on it. This message card is delivered to shop 9, which deals in merchandise X. Shop 9 sends a message card with merchandise X to recipient 7. Merchandise X could also be procured from a designated shop in the same location as recipient 7.

With this invention, a person can remotely create a card with a photo on it, such as a postcard with his own picture, no matter where he is. Even if there are no postal facilities, he can send picture postcards to his family and friends in a short time from any part of the world at any hour of the day or night. In addition to this, this system reduces the operating cost by, for example, eliminating the cost of collecting the cards by postal workers, and it offers improved service.

A variety of embodiments are possible to remotely create and send a card of the present invention. Thus, while exemplary embodiments of the invention have been described and illustrated, the present invention is not to be considered as limited by such descriptions and illustrations, but is only limited by the scope of the appended claims.

What is claimed is:

1. A method for remotely creating a picture card with a photo and mailing out the same, said method comprising the steps of:
transmitting to a remote print shop a sender's image data and text data, said text data including at least a recipient's name and address, via a computer network to a computer system at a remote print shop;
receiving said image data and text data at the remote print shop;
creating remotely the picture card with the image data and text data; and
mailing out the picture card from the remote print shop to the recipient.

2. A method of claim 1 wherein text data transmitted to a remote print shop further comprises sender's name.

3. A method for remote creation of a picture card with a photo and mailing out of the same according to claim 1, wherein said picture card is a postcard on which said image data and a message in the text data are printed on the back of said postcard, and the name and address of the recipient on the front of said postcard.

4. A system for remotely creating a picture card with a photo and mailing out the same, comprising:
a photo terminal provided at a user site, the terminal provided with an image input mechanism to input image data to be printed on said picture card, a text input mechanism to input a text data of the sender and recipient, and a communication mechanism for transmitting to a remote print shop said image data and said text data via a computer network; and
an order receiving mechanism in a computer system at said remote print shop to receive an order to remotely create and mail out the picture card from said remote print shop.

5. A system according to claim 4, wherein the photo terminal comprises a cell phone with a built-in digital camera.

6. A system according to claim 4, wherein the photo terminal comprises a personal computer capable of accepting image input.

7. A system according to claim 4, wherein the photo terminal, comprises:
an image processing device in a housing which can be set up on the ground, the image processing device comprising:
an imaging mechanism to photograph a customer and process image data of said photo;
a text input mechanism to input text data of the customer and a recipient;
a display mechanism to display the image data and the text data;
an illumination device provided with the housing to illuminate the customer; and
a communication device which can be connected to the remote print shop via the computer network.
